(19) United States
(12) Patent Application Publication
(10) Pub. No.: US 2008/0012452 A1
(43) Pub. Date: Jan. 17, 2008

(54) Brushless Motor Having a Contact-less Sensor

(75) Inventors: Hironori Tsukamoto, Kyoto (JP); Teppei Sakai, Kyoto (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NIDEC CORPORATION, Kyoto (JP)

(21) Appl. No.: 11/457,469

(22) Filed: Jul. 14, 2006

(51) Int. Cl. H02K 7/00; H02K 11/00

(52) U.S. Cl. 310/68 B; 310/67 R; 310/156.05

(57) ABSTRACT

To control low-speed rotation of a motor, a contact-less sensor for reading rotation information on the back surface of a discoid disc is fixed on a radially outside portion of a rotary part. The distance between a detection face of the contact-less sensor and the back surface of the discoid disc is adjusted by bending a mounting plate.

### BACKGROUND OF THE INVENTION

1. Technical Field

The present invention relates to structures for attaching brushless motor contact-less sensors that detect information as to the rotation of discoid discs.

2. Description of the Related Art

In recent years, a demand for rendering a surface of a discoid disc such as a CD or DVD is increasing. Rendering on a discoid disc is performed by irradiating the discoid disc with a laser beam of an optical pickup device which records/reproduces a discoid disc in a low-speed rotation state of a few hundreds revolutions per minute of a brushless motor (hereinafter, simply called a motor). In normal recording/reproduction of a discoid disc, the motor rotates at thousands revolutions per minute or even at ten thousand or higher revolutions per minute. Consequently, position detecting structure adapted to the low-speed rotation speed control is necessary in addition to the rotation speed control of recording/reproduction of a discoid disc.

A conventional structure of attaching a contact-less sensor 4 will be described with reference to FIG. 8. FIG. 8 is a side view of a motor.

With reference to FIG. 8, a mounting plate 2 is fixed below in the axial direction of a rotary part 1 rotating around a rotation axis. On an upper face of the mounting plate 2, a foldable flexible circuit board 3 (herein below, simply called FPC) is fixed. The contact-less sensor 4 is constructed by an optical device 5 mounted on an upper face of the FPC 3, and a resin bed 7 fixed on the upper face of the mounting plate 2 and determining the distance between an optical disk 6 and the optical device 5. The portion on which the optical device 5 is mounted in the FPC 3 is fixed to an upper face of the resin bed 7, thereby determining the position in the axial and radial directions of the optical device 5. The resin bed 7 is fixed to the mounting plate 2 by a screw 8 from a lower face of the mounting plate 2.

However, the conventional structure of attaching the contact-less sensor 4 requires the resin bed 7 and the screw 8 besides the optical device 5. The number of parts is therefore large, and it is difficult to lower the price of a motor. Further, by fixing the resin bed 7 with the screw 8, a gap may be generated between the mounting plate 2 and the resin bed 7. At the time of attaching the optical device 5, accuracy of the upper face and the lower face of the resin bed 7 and accuracy of perpendicularity to the mounting plate 2 of the side face have to be considered. Since an error in the accuracy of the faces of the resin bed 7 and the accuracy of perpendicularity is accumulated in the mounting plate 2, it is difficult to position the optical device 5 with high accuracy.

### BRIEF SUMMARY OF THE INVENTION

According to the present invention, an attaching structure capable of fixing a contact-less sensor with high accuracy without increasing the number of parts for fixing the contact-less sensor and a motor employing the attaching structure can be provided.

A motor of the present invention includes: a rotary part having a rotor magnet rotating around a rotation axis as a center, and a turn table disposed above the rotor magnet in the axial direction and on which a discoid disc can be mounted detachably; and a fixed part including a stator having a surface facing the rotor magnet, a mounting plate disposed below the stator, a flexible circuit board which is fixed on an upper face of the mounting plate, and a contact-less sensor fixed to the circuit board and can read a positional information on a back surface of the discoid disc.

In the structure of attaching the contact-less sensor of the invention, a mounting part is provided on a radially outside portion of the rotary part on the mounting plate, the contact-less sensor being mounted thereon. The mounting part having a face which is almost parallel with an upper face of the mounting plate and is in a position different from that of the upper face of the mounting plate in the axial direction; and a bend portion connecting the mounting part and the mounting plate formed by plastic working on the mounting plate to bend a portion thereof. The contact-less sensor is mounted on the mounting part.

According to the invention, a resin bed and a screw for fixing the resin bed to an mounting plate which are conventionally necessary to determine the height in the axial direction of the contact-less sensor to determine a fixing position of the contact-less sensor by bending the mounting plate can be made unnecessary. Therefore, the number of parts can be reduced as compared with a conventional structure.

The mounting part of the mounting plate of the invention has a projection formed from a lower face by plastic working, and a through hole in which the projection is inserted is formed in a circuit board corresponding to the mounting part. A reinforcement plate is fixed to a lower face of the circuit board corresponding to the mounting face.

With the configuration, the circuit board can be stably fixed to the mounting part with high precision.

The bend portion on the mounting part of the mounting plate of the invention connects the radially outside portion of the rotary part and/or the circumferentially side portion of the mounting part to the mounting plate.

With the configuration, a gap in the axial direction between the rotary part and the circuit board can be prevented from becoming extremely narrow due to the influence of the bended part. As a result, contact between the rotary part and the circuit board can be prevented.

### BRIEF DESCRIPTION OF THE SEVERAL VIEWS OF THE DRAWINGS

FIG. 1 is a schematic cross section taken in the axial direction of an embodiment of a motor according to the present invention;

FIG. 2 is a top view of the motor of FIG. 1;

FIG. 3 is a side view of the motor of FIG. 1;

FIG. 4 is an enlarged view of a dot-line circle in FIG. 3;

FIG. 5 is an enlarged view of a dot-line circle in FIG. 2;

FIG. 6 is a diagram showing the positional relation in the radial direction between a contact-less sensor and a disc-shaped disc;

FIG. 7 is a diagram showing another embodiment of the attaching structure of the position detecting structure according to the invention; and

FIG. 8 is a diagram showing a conventional motor.

### DETAILED DESCRIPTION OF THE INVENTION

### General Structure of Motor

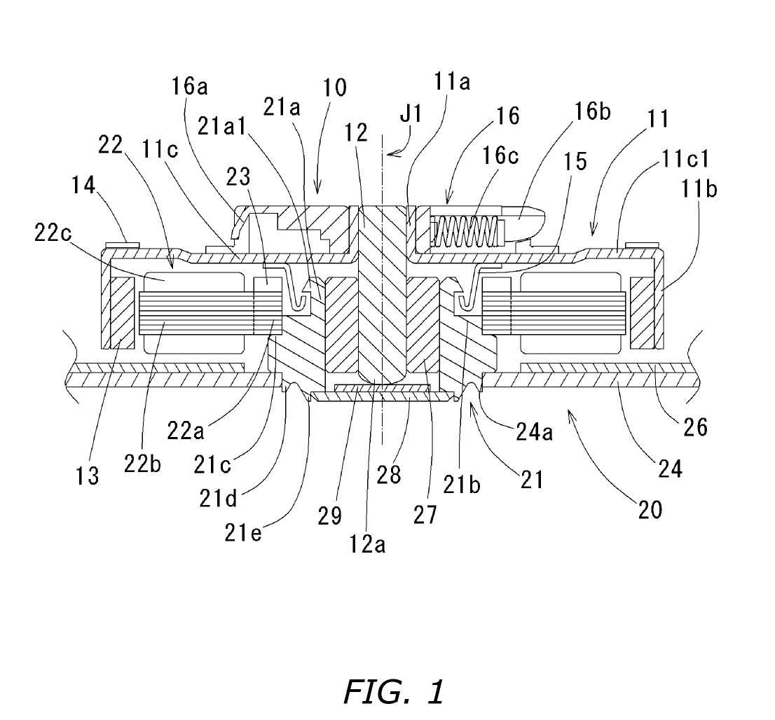

An embodiment of a motor according to the invention will be described with reference to FIG. 1. FIG. 1 is a schematic cross section taken along the axial line of a motor.

Referring to FIG. 1, a brushless motor is constructed by a rotary part 10 rotating around a rotation axis J1 as a center and having a rotor magnet to be described later which rotates a disc-shaped discoid disc (not shown in FIG. 1), and a fixed part 20 having a stator 22 which will be described later and has a surface facing the rotor magnet in the radial direction.

The fixed part 20 will be described first.

A bush 21 made of a metal material is formed in an almost cylindrical shape having a cylindrical inner surface. In an upper part in the axial direction of the bush 21, a thin cylindrical part 21a is formed. On the outer peripheral side of a lower part in the axial direction of the cylindrical part 21a, a radial-direction extended part 21b extended outward in the radial direction so as to increase the thickness is formed. On the outside in the radial direction of the radial-direction extended part 21b, a stator mounting part 21c on which the stator 22 is mounted is formed as a step in the radial-direction extended part 21b. An outer caulking part 21d and an inner caulking part 21e are formed on the outer and inner sides, respectively, in the lower end face in the axial direction of the bush 21.

The stator 22 is constructed by an annular-shaped core back 22a which is in contact with and fixed to the stator mounting part 21c, teeth 22b extending radially from the core back 22a, and a coil 22c wound around the teeth 22b via a not-shown insulating member or insulating coating. An annular-shaped pre-load magnet 23 is fixed on the top face in the axial direction of the core back 22a. By attraction generated by a magnetic force between the pre-load magnet 23 and the under face in the axial direction of a cover 11c of a rotor holder 11 which will be described later, the position in the axial direction of the rotary part 10 is stabilized.

An mounting plate 24 made of a steel plate material has a circular opening hole 24a. The inner face of the opening hole 24a and its periphery come into contact with the outer caulking part 21d of the bush 21 and the under face of the stator mounting part 21c, and the outer caulking part 21d is plastic-deformed to the outer periphery side by caulking and fixed.

A flexible circuit board 26 such as an FPC is fixed on the top face in the axial direction of the mounting plate 24. Hall devices (not shown) are disposed between slots of the teeth 22b of the stator 22 in the circuit board 26. By the Hall devices, the magnetic poles in the circumferential direction of a rotor magnet 13 which will be described later are detected, and rotation control at the time of high speed of the rotary part 10 is performed.

A sleeve 27 obtained by forming a sintered body impregnated with oil in an almost cylindrical shape is fixed to the inner surface of the bush 21. A disc-shaped plate 28 covering the inner surface of the bush 21 is fixed to the inner caulking part 21e of the bush 21 by plastic-deforming the inner caulking part 21e to the inner side by caulking. On the top face in the axial direction of the plate 28, an almost disc-shaped thrust plate 29 formed of a resin material having excellent slidability is disposed.

Next, the rotary part 10 will be described.

The rotor holder 11 formed in an almost cylindrical shape obtained by plastic-working a magnetic metal plate is disposed almost coaxially with the rotation axis J1. In the rotor holder 11, an inner cylindrical part 11a and an outer cylindrical part 11b are formed. A shaft 12 rotating around the rotation axis J1 as a center is fixed to the inner surface of the inner cylindrical part 11a by a combination of press fitting and/or adhesion. The shaft 12 is inserted along the inner surface of the sleeve 27. A lower end face 12a of the shaft 12 is formed in an almost hemispherical shape, and slides along the thrust plate 29. Therefore, the shaft 12 is rotatably supported in the radial and axial directions by the sleeve 27 and the thrust plate 29.

A rotor magnet 13 having an almost annular shape is fixed to the inner surface of the outer cylindrical part 11b of the rotor holder 11 by adhesion. The inner surface of the rotor magnet 13 and the outer surface of the teeth 22b of the stator 22 face each other via a gap in the radial direction.

The cover 11c coupling the inner and outer cylindrical parts 11a and 11b of the rotor holder 11 is formed. A rubber mounting face 11c1 annularly swollen upward in the axial direction is formed on the outside in the radial direction of the cover 11c. On an upper face in the axial direction of the rubber mounting face 11c1, an annular-shaped rubber 14 on which a disc-shaped disc is mounted is fixed via an adhesive. A hook-shaped retaining member 15 is fixed to a lower face in the axial direction of the cover 11c by welding. An engagement part 21a1 extending outward in the radial direction is formed in the outer peripheral surface of the upper part in the axial direction of the cylindrical part 21a of the bush 21. By disposing the engagement part 21a1 and the retaining member 15 so as to overlap in the axial direction, a retaining mechanism is formed.

A turn table 16 having an almost covered cylindrical shape for aligning the rotation center of a discoid disc and the rotation axis J1 and holding a discoid disc is fixed to the outer surface of the inner cylindrical part 11a of the rotor holder 11 by press fitting and/or adhesion. The lower face of the turn table 16 comes into contact with an upper face of the cover 11c of the rotor holder 11, thereby determining the position in the axial direction.

The turn table 16 is constructed by an alignment nail 16a which comes into contact with the inner face of the opening hole in the disc-shaped disk to align the rotation center of the discoid disc with the rotation axis J1, a holding member 16b for holding the inner face of the discoid disc and the inner rim of an upper face in the axial direction by being projected outward in the radial direction, and a coil spring 16c for energizing the holding member 16b outward in the radial direction.

By passing current to the coil 22c of the stator 22 from an external power supply (not shown), a magnetic field is generated around the stator 22. The rotary part 10 rotates by the interaction between the magnetic field and the rotor magnet 13.

### Contact-Less Sensor Attaching Structure

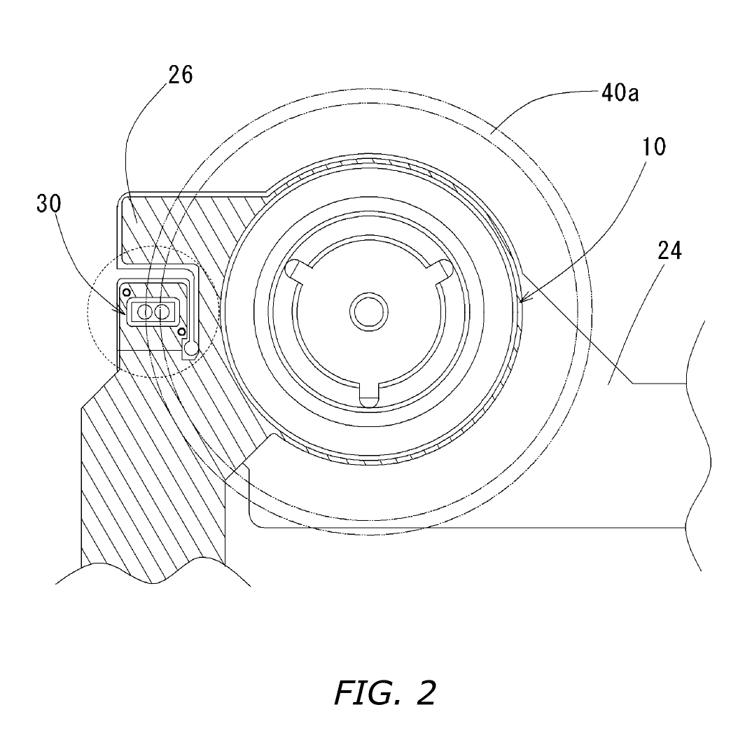

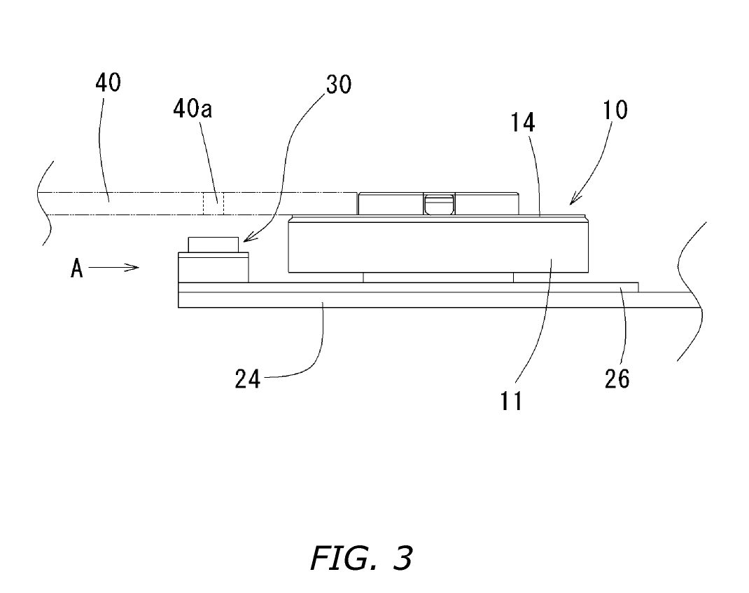

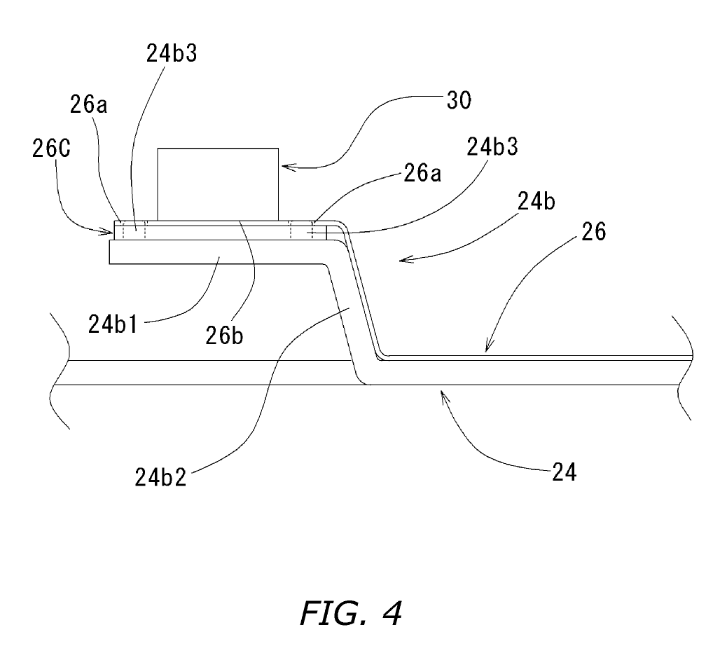

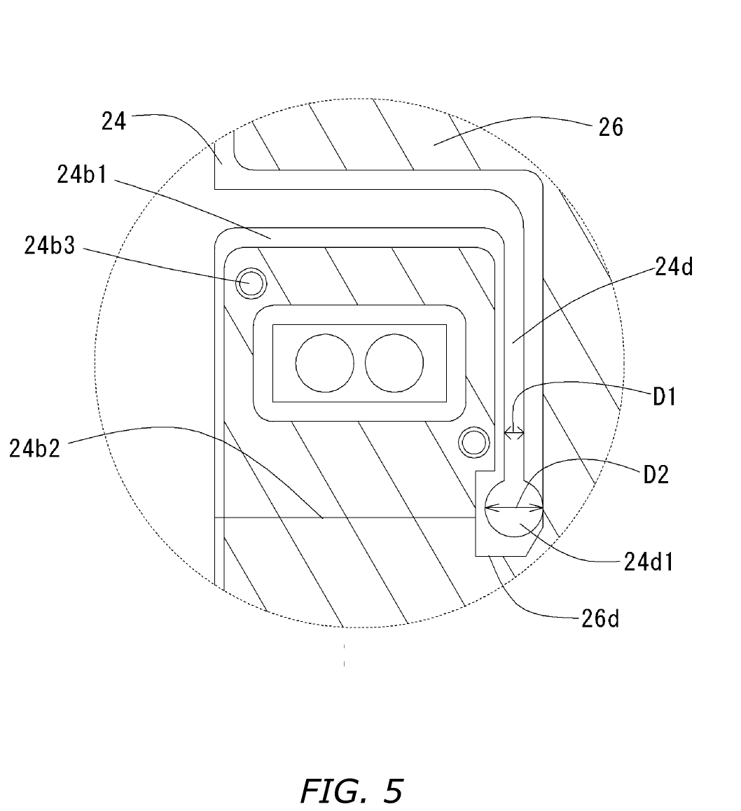

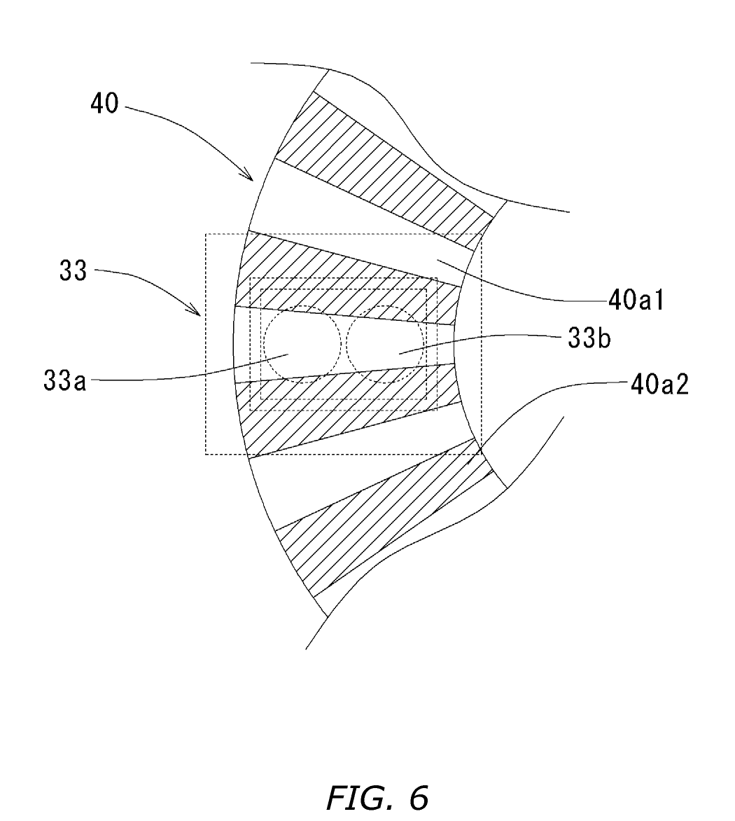

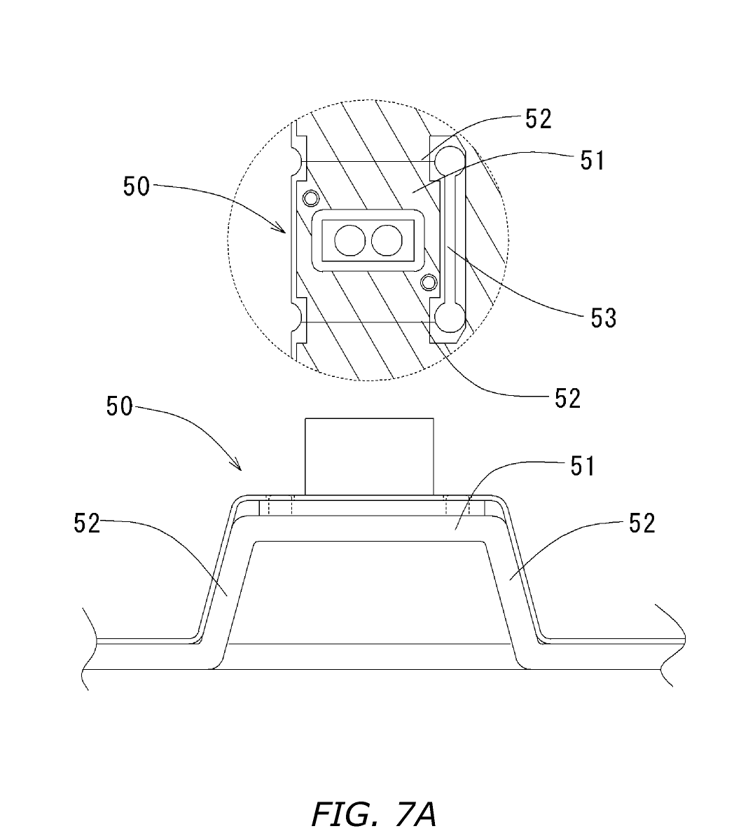

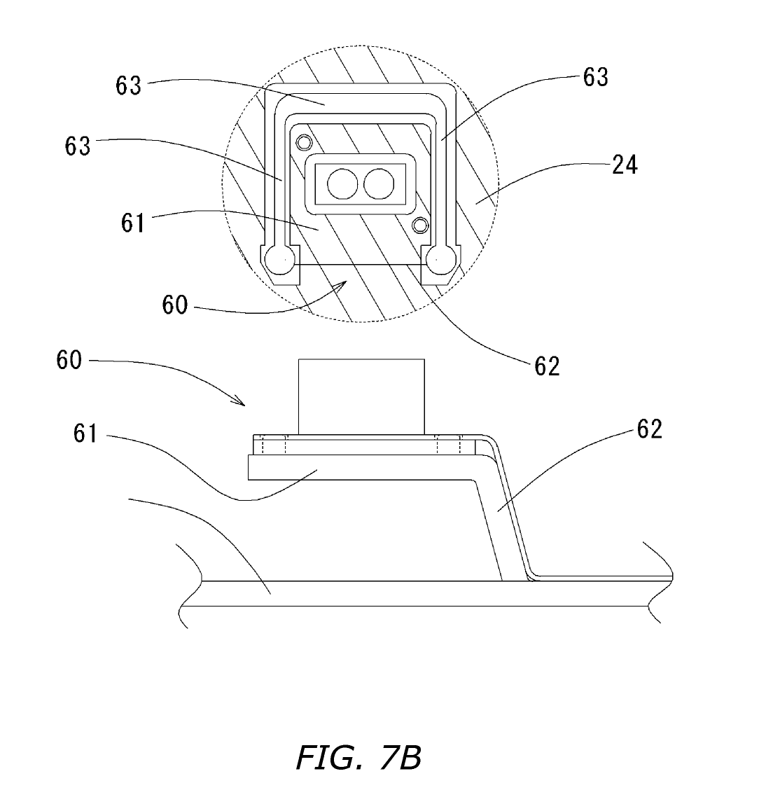

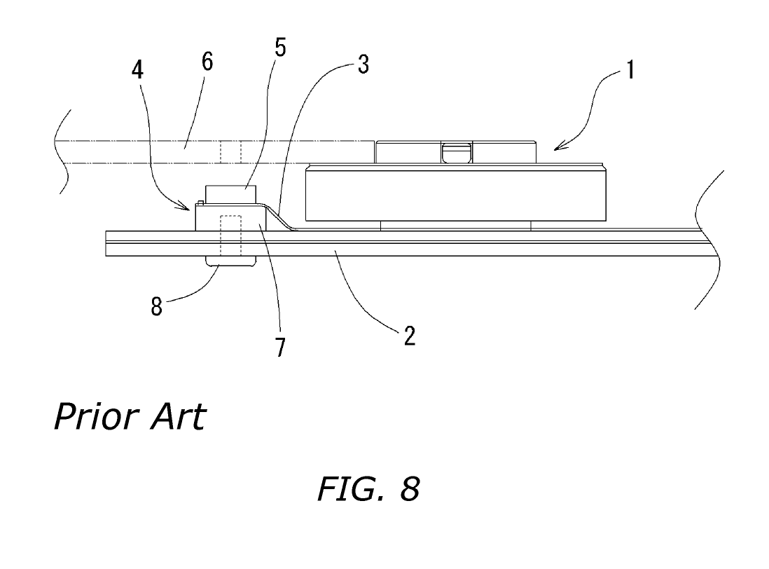

The attaching structure of the contact-less sensor of the present invention will now be described with reference to FIGS. 2 to 7. FIG. 2 is a top view of a motor. FIG. 3 is a side view of the motor. FIG. 4 is an enlarged view of the contact-less sensor seen from the arrow A of FIG. 3. FIG. 5 is an enlarged view of a dot-line circle in FIG. 2. FIG. 6 is a diagram showing the positional relation in the radial direction between the position detecting device and a pattern forming part. FIG. 7 shows another embodiment of the attaching structure of the position detecting structure. FIG. 7 is an enlarged view of the dot-line circle of FIG. 2 like FIG. 4. A hatched portion in FIG. 2 expresses the circuit board 26. In FIG. 4, only the mounting plate 24, the circuit board 26, and the contact-less sensor 30 are shown.

With reference to FIG. 2, the contact-less sensor 30 is disposed in the outer vicinity in the radial direction of the rotor holder 11 of the rotary part 10 in the circuit board 26.

An annular-shaped pattern forming part 40a is formed concentrically between the center opening hole in a discoid disc 40 and the recording area on the outer peripheral side. The contact-less sensor 30 is disposed so as to include all of the area of the pattern forming part 40a in the radial direction. The contact-less sensor 30 is preferably a photo sensor for emitting/receiving light.

With reference to FIG. 3, a detection face is positioned in an upper face of the contact-less sensor 30. The contact-less sensor 30 is disposed at a level slightly below an upper face of the rubber 14 in the axial direction. When the discoid disc 40 is mounted on the upper face in the axial direction of the rubber 14, the detection face of the contact-less sensor 30 faces a lower face in the axial direction of the discoid disc 40 with a small gap (about 2 mm).

Referring to FIGS. 4 and 5, an mounting part 24b to which the contact-less sensor 30 is attached of the mounting plate 24 is constructed by a mounting face 24b1 on which the contact-less sensor 30 is mounted and a bend portion 24b2 connecting the mounting face 24b1 and the mounting plate 24. The bend portion 24b2 is formed by plastic working such as press working. An upper face of the mounting face 24b1 is almost parallel with the upper face of the mounting plate 24 which is connected to the mounting part 24b. Since the mounting part 24b is not constructed by the conventional resin bed 7 and the screw 8 for fixing the resin bed 7 to the mounting plate 2 as shown in FIG. 7 but is formed by plastic working on the mounting plate 24, it is unnecessary to use the resin bed 7 and the screw 8. Therefore, the mounting part 24b can be formed without increasing the number of parts, so that the price of the motor can be lowered.

A projection 24b3 is provided for the mounting face 24b1. The projection 24b3 is provided by plastic working such as press working from the under face of the mounting face 24b1. As shown in FIG. 2, the projections 24b3 are provided in two places in the mounting face 24b1.

In positions corresponding to the projections 24b3 formed in the mounting face 24b1 in the circuit board 26, through holes 26a are provided. By inserting the projections 24b3 in the through holes 26a, the position in the radial and circumferential directions of the contact-less sensor 30 fixed on an upper face of the circuit board 26 can be determined easily with high precision.

A reinforcement plate 26c as a thin plate made of an insulating resin material is fixed to a lower face of a mounting face corresponding part 26b which corresponds to the mounting face 24b1 in the circuit board 26. By fixing the reinforcement plate 26c to the lower face of the circuit board 26, the circuit board 26 can be fixed to the mounting face 24b1 with high precision. In particular, in the case of using an FPC as the circuit board 26, the FPC is very thin, has a thickness of about 0.1 mm, and is made of a very soft material such as a resin material. Consequently, at the time of fixing the circuit board 26 to the upper face of the mounting face 24b1, the circuit board 26 may be fixed in a state where its upper face is deformed in a wavelike shape. It may cause a problem such that the contact-less sensor 30 fixed on the upper face of the circuit board 26 is tilted in the circumferential and axial directions and rotation information cannot be detected with high precision. However, by fixing the reinforcement plate 26c to the lower face of the circuit board 26, fixing between the mounting face 24b1 and the circuit board 26 becomes fixing between the mounting face 24b1 and the reinforcement plate 26c. Therefore, the circuit board 26 can be prevented from being deformed in a wavelike shape at the time of fixing.

Through holes are formed also in the reinforcement plate 26c in positions corresponding to the projections 24b3 formed in the mounting face 24b1. Only with the circuit board 26, in the case where the attachment position is slightly deviated in the radial and circumferential directions, a stress is applied. Since the FPC as the circuit board is formed thinly by using the soft material as described above, a wiring pattern (not shown) for bringing the contact-less sensor 30 into conduction, which is provided around the projections 24b3 may be disconnected due to the stress. However, the positioning in the radial and circumferential directions to the projections 24b3 is performed with the reinforcement plate 26c, so that no stress is directly applied to the circuit board 26. Thus, the wiring pattern can be prevented from being disconnected.

The height from the upper face of the mounting plate 24 to an upper face of the projection 24b3 is desirably equal to or lowers than the height from the upper face of the mounting plate 24 to the upper face of the circuit board 26. Since the projection 24b3 is formed by plastic working, the coupling part between the upper face of the projection 24b3 and the circumferential face has an R shape. Therefore, the diameter of an upper part of the projection 24b3 becomes smaller. Even if the positions in the radial and circumferential directions of the circuit board 26 and the projection 24b3 are slightly deviated, the projection 24b3 and the circuit board 26 do not come into direct contact with each other, so that the projection 24b3 can be prevented from applying a stress to the circuit board 26.

Referring to FIG. 2, the bend portion 24b2 is formed on a radially outside portion of the rotary part 20. The bend portion 24b2 is preferably formed at the periphery other than the periphery facing the rotary part 20 of the mounting face 24b1. When the bend portion 24b2 is formed at the periphery facing the rotary part 20 of the mounting face 24b1, there is the possibility that the bend portion 24b overlaps the rotary part 20. As a result, the gap in the axial direction between the circuit board 26 and the rotary part 20 becomes extremely narrow and may come into contact with each other. In particular, in the case where the circuit board 26 is an FPC, the FPC may be fixed to the portion facing the rotary part 20 in the axial direction in a slightly waved shape. As a result, the waved portion of the FPC comes into contact with the rotary part 20. In the case where the rotary part 20 is attached in a slightly tilted manner, if the gap in the axial direction between the circuit board 26 and the rotary part 20 is extremely narrow, the rotary part 20 and the circuit board 26 may come into contact with each other. As a result, a problem such that the wiring pattern on the circuit board 26 is disconnected and a problem of sound of a contact between the circuit board 26 and the rotary part 20 occur. When the bend portion 24b2 is formed in a position on the outside in the radial direction largely apart from the rotary part 20 in order to avoid the problems, it is difficult to reduce the size in the radial direction of the motor. Consequently, a slit 24d that separates the mounting face 24b1 and the mounting plate 24 is provided between the periphery facing the rotary part 20 of the mounting face 24b1 and the mounting plate 24 facing the periphery. The slit 24d may be formed in the periphery other than the bend portion 24b2. The bend portion 24b2 connects the radially outside portion of the outer cylindrical part 11b of the rotor holder 11 and/or the circumferentially side portion of the mounting part. Similarly, a slit 26d is formed in the circuit board 26.

In the case of providing the bend portion 24b2 at the periphery facing the rotary part 20 of the mounting face 24b1, the slit 24d is formed to separate the bend portion 24b2 and the mounting plate 24 from each other. Consequently, the slit 24d has to be formed so as to extend toward the rotary part 20. With the configuration, the distance in the radial direction between the inner periphery of the slit 24d and the inner periphery of the opening hole 24a is shortened. As a result, the mounting plate 24 may be deformed by caulking between the opening hole 24a and the outer caulking part 21d of the bush 21. Therefore, since the mounting plate 24 itself is deformed, the precision of the mounting face 24b1 may deteriorate.

At an end of the slit 24d, a through hole 24d1 having width D2 larger than width D1 of the slid 24d is formed. By having the through hole 24d1, formation of the bended part 24d2 can be facilitated (refer to FIG. 5).

With reference to FIG. 6, the pattern forming part 40a of the discoid disc 40 is constructed by alternately disposing reflection pattern parts 40a1 and non-reflection pattern parts 40a2 each having a predetermined width in the circumferential direction. The contact-less sensor 30 has a light emitting part 30a that emits light and a light receiving part 30b that receives light. Light emitted from the light emitting part 30a of the contact-less sensor 30 is reflected by the reflection pattern part 40a1, and the reflected light is received by the light emitting part 30b. On the other hand, the non-reflection pattern parts 40a2 absorb the light emitted from the light emitting part 30a, so that the light is not received by the light receiving part 30b. Therefore, pulse signals according to a light/dark pattern in the pattern forming part 40a can be obtained. The recording face of the discoid disc 40 is formed in one face in the axial direction. The pattern forming part 40a is formed in a label face as a face on the side opposite to the recording face of the discoid disc 40 in the axial direction.

The brushless motor having the position detecting structure 30 is disposed in a disk driving apparatus. In the apparatus, for the discoid disc 40 mounted on the rubber 14 in the turn table 16 in the rotary part 10, a laser pickup (not shown) for accessing the recording surface of the discoid disc 40 is provided so as to be movable in the radial direction of the discoid disc 40 on the mounting plate 24 side.

When the discoid disc 40 is mounted on the turn table 16 and the rubber 14 with the label face of the discoid disc 40 directed to the mounting plate 24 side, the contact-less sensor 30 performs optical position detection on the pattern forming part 40a formed in the label face. On the basis of the position detection signal, low-speed rotation control on the rotary part 10 is performed.

Another structure of the mounting part 24b will now be described with reference to FIGS. 7A and 7B. In FIGS. 7A and 7B, mounting parts 50 and 60 will be described.

As shown in FIG. 7A, the mounting part 50 may have two bend portions 52. A slit 53 is provided in a periphery facing the rotary part 20 of a mounting face 51. As compared with the case where only one bend portion 52 is provided, the strength of the bend portions 52 can be improved. Further, a through hole 54 is formed at an end of the slit 53. The inside diameter D3 of the through hole 54 is larger than width D4 of the slit 53. With the through hole 54, the mounting face 51 can be easily formed. As shown in FIG. 7B, in the case where the mounting part 60 in a portion surrounded by the mounting plate 24 is formed, a slit 63 may be provided in the periphery other than a bended part 62 of a mounting face 61. A through hole 64 is formed at an end of the slit 63. The inside diameter D5 of the through hole 64 is larger than width D6 of the slit 53. With the through hole 64, the mounting face 61 can be easily formed.

Although the embodiment of the present invention has been described above, the invention is not limited to the embodiment but can be modified within the scope of claims.

For example, although the Hall devices are used for the rotation control at the time of high-speed rotation of the rotary part 10 in the foregoing embodiment, the invention is not limited to the Hall devices. As long as rotation control at the time of high-speed rotation can be performed, another sensor such as a magnetic sensor or an optical sensor may be used. Alternately, a method of performing the rotation control by detecting back electromotive force of the coil 22c without using such a sensor may be employed.

What is claimed is:

1. A brushless motor, comprising:
a rotary part having a rotor magnet rotating around a rotation axis as a center, and a turn table disposed above the rotor magnet in an axial direction and on which a detachable discoid disc can be mounted detachably;
a fixed part including a stator having a surface facing the rotor magnet, an attachment plate disposed below the stator, a flexible circuit board which is fixed on an upper face of the attachment plate, and a contact-less sensor fixed to the circuit board and can read a positional information on a back surface of the discoid disc; and
an attachment part is provided on a radially outside position of the rotary part, the contact-less sensor being mounted thereon, wherein:
the mounting part having a face which is almost parallel to an upper face of the mounting plate and is in a position different from that of the upper face of the mounting plate in the axial direction;
a bended portion connecting the mounting part to the mounting plate by plastic working on the mounting plate to bend a portion thereon; and
the contact-less sensor is mounted on the mounting part.

2. A brushless motor according to claim 1, wherein
a projection is formed upward in the axial direction from an lower face of the mounting part of the mounting plate;
a through hole is formed in a position corresponding to the projection, in the circuit board; and
by inserting the projection in the through hole, the position in the radial direction and the circumferential direction between the mounting part and the circuit board corresponding to the mounting part is determined.

3. A brushless motor according to claim 1, wherein a reinforcement plate which improves rigidity of the circuit board is fixed to the lower face of the circuit board corresponding to the mounting part.

4. A brushless motor according to claim 1, wherein the bent portion on the mounting plate connects the radially outside portion and/or the circumferentially side portion of the mounting part to the mounting plate.

5. A brushless motor according to claim 1, wherein the bended part of the mounting plate is formed on the outside in the radial direction of the rotary part.

6. A brushless motor according to claim 1, wherein a slit for separation from the mounting plate is provided in at least one face of the periphery of the mounting part.

7. A brushless motor according to claim 6, wherein the slit is provided in a periphery facing the rotary part side of the mounting part.

8. A brushless motor according to claim 6, wherein a through hole wider than the slit is formed in at least one of ends of the slit.

9. A brushless motor, comprising:
a rotary part having a rotor magnet rotating around a rotation axis as a center, and a turn table disposed above the rotor magnet in an axial direction and on which a detachable discoid disk can be mounted detachably;
a fixed part including a stator having a surface facing the rotor magnet in the radial direction, an mounting plate disposed below the stator, a flexible circuit board which is fixed on an upper face of the mounting plate, and a contact-less sensor fixed to the circuit board and can read a positional information on a back surface of the discoid disk; and
a mounting part is provided at a radially outside portion of the rotary part on the mounting plate, the contact-less sensor being mounted thereon, wherein:
the mounting part having a face which is almost parallel with an upper face of the mounting plate and is in a position different from that of the upper face of the mounting plate in the axial direction; and
a bent portion connecting the mounting part to the mounting plate by plastic working on the mounting plate to bend a portion thereof;
the bent portion is provided in a place other than a periphery facing the rotary part of the mounting part;
a part other than the bent portion in the periphery of the mounting part is separated from the mounting plate; and
the contact-less sensor is mounted on the mounting part.
